(19) United States
(12) Patent Application Publication
(10) Pub. No.: US 2024/0024981 A1
(43) Pub. Date: Jan. 25, 2024

(54) LASER MACHINING HEAD AND METHOD FOR MACHINING A WORKPIECE

(71) Applicant: Precitec GmbH & Co. KG, Gaggenau (DE)

(72) Inventors: Tom WALDE, Offenburg (DE); Rüdiger MOSER, Malsch (DE); Larisa Tatarinova, Ettlingen (DE)

(21) Appl. No.: 18/349,352

(22) Filed: Jul. 10, 2023

(30) Foreign Application Priority Data
Jul. 20, 2022 (DE) 10 2022 118 147.2

(51) Int. Cl. B23K 26/04; B23K 26/03; B23K 26/082

(52) U.S. Cl. CPC B23K 26/048; B23K 26/032; B23K 26/082

(57) ABSTRACT

A laser machining head for machining a workpiece by means of a laser beam, includes: a scanning device for directing the laser beam at a plurality of positions on a workpiece surface; an image acquisition device for acquiring an image of the workpiece surface, said image acquisition device including an objective with a lens having an adjustable focal length; and a control configured to adjust a focal length of the lens based on a measurement value.

### CROSS-REFERENCE TO RELATED APPLICATIONS

This application claims priority to German Patent Application No. 10 2022 118 147.2, filed Jul. 20, 2022, which is hereby incorporated by reference in its entirety.

### FIELD OF THE INVENTION

The present invention relates to a laser machining head for machining a workpiece by means of a laser beam including an image acquisition device for capturing an image of the workpiece surface. The invention also relates to a method for machining a workpiece using a laser beam, with an image of the workpiece surface being captured.

### BACKGROUND OF THE INVENTION

In laser machining, image acquisition of the workpiece surface to be machined is often carried out, for example, to determine a position of the laser beam on the workpiece surface or a position of features on the workpiece surface or to monitor the laser machining process. Herein, the focus for the image acquisition must be adjusted and/or readjusted in order to image different machining levels, for example in the case of uneven workpiece surfaces, in a sharp manner. The machining level is the level in which a (machining) laser beam hits the workpiece surface.

Laser machining heads, in particular scanner welding systems, may have an integrated gray image functionality via a camera system with a fixed focal length. However, the depth of focus of a camera lens with a fixed focal length is limited. Therefore, often gray images which are blurred in some areas and/or levels are acquired. The depth of focus is often insufficient, especially in applications with relatively large height differences between the features to be recognized in the gray image. Since a trade-off between the various levels is often made with regard to the focus setting of the lens of the camera system, the area of optimal sharpness is usually between the individual machining levels so that each machining level is “slightly” blurred. The consequence of this is that the acquired gray image is either not suitable for carrying out an exact position determination by means of image processing or that significantly more complex and therefore more algorithms more intensive in computing time are required for the evaluation, because image processing works fastest and most reliably with sharp high-contrast gray images.

This problem is exacerbated for scanner applications: For a so-called scanner laser machining head, i.e. a laser machining head with a scanning device for directing the laser beam at a large number of positions on the workpiece, the machining area is relatively large so that, even with flat workpiece surfaces, it may be impossible a central area and the peripheral areas to be focused simultaneously.

The focal position of the camera system is usually adjusted mechanically, e.g. by motor-driven displacement of the camera lens in the axial direction. EP 1 716 963 B 1, for example, discloses an optical assembly for remote laser material machining, tracking with a lens for a gray image camera being performed mechanically in the direction of light propagation. DE 10 2012 111 090 B4 discloses a device in which the length of the beam path is changed by means of a rotating minor in order to focus a light beam.

However, mechanical tracking or displacement of optical elements is slow, complex in terms of design, and expensive. The mechanical tracking with optical elements also requires sufficient space in the laser machining head for arranging the components required therein. In addition, with moving elements in the optics space of the laser machining head, abrasion caused by the movement may become a problem.

### SUMMARY OF THE INVENTION

It is therefore an object of the present invention to provide a laser machining head, in particular a scanner laser machining head, with an image acquisition device that can be used for different machining levels.

A further object of the present invention is to provide a compact laser machining head, in particular a scanner laser machining head, with an image acquisition device.

Furthermore, an object of the present invention is to provide a laser machining head, in particular a scanner laser machining head, including an image acquisition device, wherein a focus position or a focal plane of the image acquisition device can be adjusted or set quickly.

A further object of the invention is to provide a laser machining head, in particular a scanner laser machining head, including an image acquisition device, wherein a focus position or a focal plane of the image acquisition device can be adjusted automatically.

Another object of the present invention is to provide a simplified and/or cost-effective laser machining head, in particular a scanner laser machining head, including an image acquisition device.

A further object is to provide a method for machining a workpiece by means of a laser beam with improved (re-)focusing of an image acquisition device on a workpiece surface.

At least one of these objects is achieved by the respective subject matter disclosed herein.

According to one aspect, a laser machining head for machining a workpiece, in particular a workpiece surface, by means of a laser beam comprises: a housing in which at least one optics for guiding and/or shaping the laser beam, for example a collimation optics and/or a focusing optics, is arranged; an image acquisition device for capturing an image of the workpiece surface, wherein the image acquisition device comprises an objective having a lens with an adjustable focal length; and a control configured to adjust a focal length of the lens based on a measurement value. The laser machining head may further comprise a scanning device for directing the laser beam at a plurality of positions on a surface of the workpiece or on the workpiece surface.

According to a further aspect, a laser machining head for machining a workpiece by means of a (machining) laser beam comprises: a scanning device for directing the laser beam at a plurality of positions on a surface of the workpiece or on the workpiece surface; an image acquisition device for acquiring an image of the workpiece surface, wherein the image acquisition device comprises an objective with a lens having an adjustable focal length; and a control configured to adjust a focal length of the lens based on a measurement value. In other words, a laser machining head for machining a workpiece by means of a (machining) laser beam may comprise: a scanning device for directing the laser beam at a plurality of positions on a surface of the workpiece or on the workpiece surface; an image acquisition device for acquiring an image of the workpiece surface, the image acquisition device comprising an objective with a liquid lens; and a control configured to adjust a focal length of the liquid lens based on a measurement. The laser machining head may comprise a housing in which at least one optics for guiding and/or shaping the laser beam, for example a collimating optics and/or focusing optics, is arranged.

The laser machining head according to one of these aspects may have the following features or effects:

According to the present invention, instead of mechanical tracking for the camera lens, the effective focal length of the lens can be realized via a lens, the focal length of which is variable, i.e. a liquid lens, for example. The advantage of such an arrangement consists in higher dynamics, lower costs and the possibility of implementing a more compact structure. As a result, the laser machining head is particularly efficient, in particular with regard to the compact, simplified and cost-effective design, the rapid response time and the possibly automated mode of operation thereof. In addition, image processing can be carried out more efficiently and reliably since sharp and high-contrast gray images can be obtained by means of the laser machining head according to the invention.

The image acquisition device may have a beam path in which the objective with the lens is arranged. The lens may be arranged in front of a sensor of the image acquisition device, e.g. a photodiode or photodiode array or a CCD sensor. The image acquisition device may be or comprise a camera, in particular a CMOS camera.

The lens has an adjustable or variable focal length. The lens with adjustable focal length may be a deformable lens. The lens with adjustable focal length may refer to a lens, the focal length of which can be adjusted, e.g., electrically and/or by deforming the lens. An example of a lens with adjustable focal length is a liquid lens. The lens may be supplemented by other optical elements with longer focal lengths in the beam path of the image acquisition device, such as by mechanical tracking of a (camera) lens. The effective focal length or the resulting total focal length of the objective and/or of all of the optical elements can then be varied and/or adjusted by means of the lens with an adjustable focal length. As a result, a focal position or focal plane of the image acquisition device can be changed.

For example, the lens may be transitioned from a first state to a second state in which the lens refracts the light more or less than in the first state. Preferably the lens has an electrically adjustable focal length, i.e. the focal length can be varied via an applied voltage.

The laser machining head may be configured to machine a workpiece, for example by laser welding, laser soldering, laser cutting and/or laser engraving etc. Accordingly, the laser machining head may be a laser cutting head, a laser welding head, a laser soldering head, a laser engraving head or the like. The workpiece may comprise a metal and/or a polymer, for example. The workpiece may also be a mechanical and/or electrical part (component), for example an electrode of a battery cell.

The laser beam may also be referred to as a machining laser beam. In terms of energy, the laser beam is suitable for machining a workpiece and may be pulsed.

The image acquisition device may be configured to capture process radiation and/or back reflections for acquiring the image of the workpiece surface. In particular, the light of the laser beam scattered and/or reflected on the workpiece surface and/or radiation generated on the workpiece surface (heat radiation, for example) may be detected. Additionally or alternatively, separately radiated light, for example white light, may be captured by the image acquisition device. A lighting unit may also be provided.

The scanning device is configured to direct the laser beam at many different positions on the workpiece surface. The scanning device may comprise one or more movably mounted mirrors. The scanning device may be configured to scan a workpiece surface.

The measurement value may be recorded or have been recorded at a point or position on the workpiece surface or correspond to a point on the workpiece surface on which the image acquisition device is to be focused by adjusting the focal length of the lens, i.e. which the image acquisition device is to image sharply by adjusting the focal length of the lens. In other words, the measurement value may correspond to a point on the workpiece surface that is to be in the focal plane of the image acquisition device.

The control may be integrated into a control of the laser machining head and/or an external control. The control may also be part of the image acquisition device.

The control may be configured to carry out image processing on the acquired image, for example to recognize features (weld seam, joint edge, orientation marker, etc.) on the workpiece surface and/or to determine a machining position for the laser beam. The control may also be configured to drive the scanning device in such a way that the laser beam is directed at the determined machining position.

The control may be configured to adjust the image acquisition device in such a way that a focal plane of the image acquisition device and/or a focal plane of the lens lies in a machining plane, i.e. in a plane in which the focal position of the laser beam lies and/or in a plane which contains the point of impact of the laser beam on the workpiece surface or in which the laser beam hits the workpiece surface. This allows for a sharp gray image to be acquired in the respective machining level. In addition or as an alternative, the control may be configured to perform open-loop and/or closed-loop control of the lens in such a way that the machining position of the laser beam on the workpiece surface lies in the sharpness plane or focal plane. In other words, the control may be configured such that a sharp image of the laser machining and/or laser machining results can be acquired at any time. The control may be configured to control the image acquisition device for an autofocus function or self-focusing function. In other words, the image acquisition device may perform an autofocus function.

The lens may be a liquid lens. The liquid lens may be, for example, a biphasic or a monophasic liquid lens or a liquid crystal-based liquid lens.

The use of a liquid lens may be particularly suitable for quickly acquiring a substantially sharp gray image. A laser machining head with a liquid lens has high dynamics and a short response time with regard to focal length adjustment and the resulting focusing. The liquid lens therefore allows the laser machining head to respond more quickly than would be the case with a mechanical or motorized adjustment or displacement of a lens. In addition, the liquid lens is particularly suitable for a compact and inexpensive laser machining head. Liquid lenses are not only fast, they also have the advantage that, as lenses with variable refractive power, they can be made particularly small and compact.

The focal length of the lens, in particular of a liquid lens, may be electrically variable or adjustable. As a result, it has a shorter focusing time or response time in the millisecond range compared to mechanical focusing systems, e.g. up to 10 ms (less than or equal to 10 ms) or even up to 5 ms. Focusing time may be defined as the delay between an electrical control signal and the optical response of the lens, i.e. reaching the desired focal length or refractive power. For mechanically operated systems (e.g., based on a displacement of a lens), the focusing time is often in the tens of milliseconds.

The lens with an adjustable focal length, in particular the liquid lens, may have a focal length range between −500 mm and +500 mm, in particular between −500 mm and +333 mm or between −100 mm and +100 mm. The focal length of the lens can be adjusted within these focal length ranges. The variable refractive power of the lens may be, for example, between about +10 dpt and about −10 dpt, or between about +2 dpt and −2 dpt, or between about +10 dpt and −2 dpt.

The image acquisition device may be used to acquire an image of the workpiece surface in an area in which the laser beam hits the workpiece surface.

The image acquisition device may comprise a camera, in particular a gray image camera. Monitoring, open-loop or closed-loop control of a laser machining operation on a workpiece can be carried out in real time in a simple manner by means of a gray image camera.

The beam path of the image acquisition device may extend at least partially coaxially to the beam path of the laser beam. The beam path of the image acquisition device (in the propagation direction of the laser beam) is preferably coupled into the beam path of the laser beam upstream of the scanning device, e.g. by means of a beam splitter. In other words, the beam path of the image acquisition device may extend over the scanning device, or the scanning device may lie both in the beam path of the laser beam and in the beam path of the image acquisition device. As a result, a detection range or field of view of the image acquisition device is deflected together with the laser beam. Since an optical path to the workpiece surface may change quickly and significantly here, rapid adjustment of the focal position or focal length of the lens is particularly advantageous.

The laser machining head may include a focusing optics for focusing the laser beam. The focusing optics may be arranged downstream of the scanning device (in the propagation direction of the laser beam). In other words, the focusing optics may be both in the beam path of the laser beam and in the beam path of the image acquisition device. The focusing optics may be or include an F-Theta lens, for example.

The measurement value may be a measured distance value, i.e. a measurement value of a distance between the laser machining head and the workpiece surface. The measured distance value may be recorded or measured at the point on the workpiece surface on which the image acquisition device is to be focused, i.e. which is to be in the focal plane of the image acquisition device or in the focal plane of the lens.

The laser machining head can further include a distance measuring device for measuring the distance value, i.e. for measuring the distance between the laser machining head and the workpiece surface. The distance measuring device may comprise at least one of the following devices: an optical coherence tomography (OCT) device, a lidar device, a ladar device, a ToF device, a conoscopy device, a light section device, a triangulation measuring device and/or a capacitive distance measuring device. The distance measuring device may be integrated in the laser machining head or arranged outside of the laser machining head.

An OCT device uses, for example, broadband light with a short coherence length over time, which is divided into two beam parts in a beam splitter. One beam part is directed onto a workpiece surface as a measuring beam. The other part of the beam runs through a reference path. The light reflected from the workpiece surface is superimposed with the reference light in an interferometer and is thus brought to interference. Distances can be determined from the interference signal. Three-dimensional images of the workpiece surface may be generated by lateral scanning over the workpiece surface.

A lidar (Light Detection and Ranging) device may be used to measure distances. Light is used to detect distances. In the case of a ladar (LAser Detection And Ranging) device, special laser light, for example in the form of a pulsed laser, is used. A ToF device may, for example, include a TOF camera and/or 3D camera systems that measure distances using a time-of-flight method (also ToF). A conoscopy device is based on the principle of the interference of two coherent light waves.

A triangulation measuring device is based on geometric distance detection, in which angles of an imaginary triangle are measured in order to determine or obtain a distance on the basis of trigonometry. A light section device is based on optical 3D measurement technology. For this purpose, a height profile is measured along a line of light projected onto a workpiece surface.

A capacitive distance measuring device is based (at least approximately) on the mode of functioning of an ideal plate capacitor. A shift in the distance between the plates, i.e. between the capacitive sensor and the workpiece surface, causes a change in the total capacitance, from which the distance between the laser machining head and the workpiece surface can then be determined.

Accordingly, the liquid lens may be driven by the control on the basis of measured distance values, which are detected or measured by the distance measuring device.

The measurement value may additionally or alternatively comprise at least one contrast value of an image of the workpiece surface that is acquired or can be acquired by the image acquisition device. The control may be configured to determine a contrast value of the acquired image.

The control may be configured to determine a distance value of the laser machining head from the workpiece surface based on the contrast value. The control may be configured, for example, to determine a distance value of the laser machining head from the workpiece surface based on the contrast value of the acquired image and a focal length set when acquiring the image.

The image can be “focused” on the basis of a contrast value obtained from an image acquired or capable of being acquired by the image acquisition device, e.g. in an autofocus function. The focal length of the lens to be set can therefore be determined based on a contrast value of the image. The at least one contrast value may be used to determine a distance between the laser machining head and the workpiece surface.

The measurement value, e.g. the contrast value and/or the measured distance value, and/or the distance value determined according to the contrast value may be used to control a motorized collimator for the laser beam. The system may be equipped with motorized adjustable collimation optics for the laser beam. The control may be configured to set a focus position of the laser beam by adjusting the collimation optics based on the measurement value and/or based on the acquired image.

The image acquisition device may have an autofocus function, in particular a passive autofocus function. The control may be configured to drive the image acquisition device so as to perform an autofocus function, for example to adjust the focal length of the lens based on a contrast value of the image. The focal length of the lens may therefore be adjusted using an autofocus function.

The control may be configured to adjust the focal length of the lens in such a way that an area, a point and/or a position on the workpiece surface at which the measurement value was recorded or which corresponds to the measurement value lies in the sharpness plane or focal plane of the image acquisition device. In other words, the focal length of the lens may be set in order to adjust the focal position of the image acquisition device to the area, location or position from which the measurement value (e.g. distance measurement value) originates.

The laser machining head may further comprise: a collimating optics for collimating the laser beam and/or a focusing optics for focusing the laser beam. At least part of the focusing optics and/or the collimation optics may be displaceable or adjustable by means of an actuator. The control may be configured to adjust a focal position of the laser beam based on the measurement value by controlling the actuator. At least part of the focusing optics and/or the collimating optics may be arranged in the laser machining head in a displaceable manner, in particular in a manner displaceable by motor, in order to set a focal position of the laser beam. The focusing optics may be arranged before or after the scanning device (in the direction of propagation of the laser beam). When the focusing optics or a part thereof is adjustable, the focusing optics is preferably arranged before the scanning device or in front of a coupling point of the beam path of the image acquisition device. In other words, in this case the focusing optics may be arranged outside of the beam path of the image acquisition device. The focusing optics may be or include an F-Theta lens, for example.

According to a further aspect, a method for machining a workpiece using a laser beam comprises: acquiring a measurement value; adjusting a focal length of a lens of an objective of an image acquisition device, setting an image of the workpiece surface by means of the image acquisition device with the set focal length. So the lens is a lens with an adjustable focal length, e.g. a liquid lens. The measurement value may be detected at a position on the workpiece surface. In other words, the measurement value may correspond to a position on the workpiece surface.

The control of the laser machining head of one of the embodiments described above may be configured to carry out the method. The method may be carried out using the laser machining head described herein and/or may comprise providing the laser machining head.

The method may further comprise acquiring the measurement value at a position on the workpiece surface that is to be in the focal plane of the image acquisition device (i.e. which is be imaged in focus).

Acquiring a measurement value may include or be acquiring a distance measurement, e.g. at a position on the workpiece surface, with the focal length of the lens being adjusted based on the acquired distance measurement. In other words, the measurement value may be the acquired distance value. For example, the focal length of the lens may be adjusted in such a way that the measured distance value acquired corresponds to the focal length or that the position at which the measured distance value was detected lies in the focal plane of the lens.

Acquiring a measurement value may include acquiring a contrast value in an image of the workpiece surface acquirable by the image acquisition device, e.g. by means of the image acquisition device and/or by the control. Based on the acquired contrast value, the focal length of the lens may then be adjusted, e.g. to obtain a sharp image of the workpiece surface or a desired part of it. The contrast value may be determined with respect to a specific feature, e.g. a mark, in the acquired or acquirable image so that the focal length is adjusted in relation to this feature. These steps, acquiring a contrast value and then adjusting the focal length of the lens, may be performed in an autofocus function of the image acquisition device. The method may further comprise: determining a distance value from the contrast value and, if necessary, the set focal length of the lens, and adjusting the focal position of the laser beam based on this distance value.

Subsequently, the image of the workpiece surface, i.e. the image acquired with the adjusted focal length, can then be evaluated, e.g. by means of image processing, for example to determine a machining position on the workpiece surface for the laser beam. The method may further comprise the step of directing the laser beam at the determined machining position.

The method for machining the workpiece can implement improved, in particular efficient and rapid (re-)focusing of the (imaging) beam path of the image acquisition device. The method may have all the advantages and technical effects of the laser machining head described herein and embodiments thereof.

### BRIEF DESCRIPTION OF THE DRAWINGS

FIG. 1 is a schematic view of a laser machining head according to an embodiment;

FIG. 2 is a schematic view of a laser machining head according to another embodiment;

FIG. 3 is a schematic view of a laser machining head according to yet another embodiment;

FIG. 4 is a schematic view of a laser machining head according to yet another embodiment; and

FIG. 5 is a flowchart that schematically illustrates a method according to an embodiment.

### DETAILED DESCRIPTION OF THE INVENTION

Unless otherwise noted, the same reference symbols are used below for the same elements and those with the same effect. A redundant description of recurring features and possibly a redundant use of recurring reference symbols are avoided as far as possible. The various embodiments and features of the figures described below can be expressly combined and are not to be understood as complete implementations.

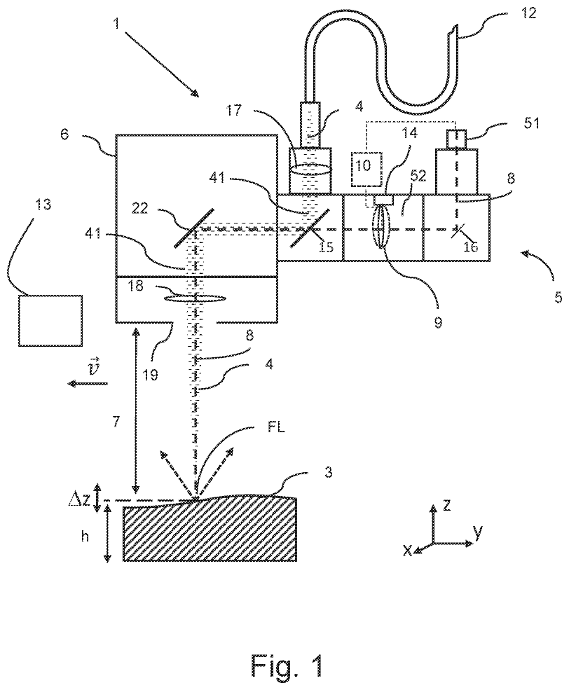

FIG. 1 is a schematic view of a laser machining head 1 according to an embodiment. The laser machining head 1 for machining a workpiece, in particular a workpiece surface 3, by means of a laser beam 4 comprises a housing 6, in which at least one optics for guiding the laser beam 4 is arranged, e.g. a focusing optics 18 for focusing the laser beam 4 and/or a collimating optics 17 for collimating the laser beam 4. The laser beam 4 is coupled into the laser machining head 1 by means of a light guide 12, for example. In FIG. 1 the laser beam 4 is directed at a position on the workpiece surface 3 via a deflection minor 22. During the laser machining process, the laser machining head 1 may be guided over the workpiece surface 3 at a speed \vec{v} in order to guide the laser beam 4 along a machining path on the workpiece surface 3. The focusing optics 18 may be an F-Theta lens. A focal position of the laser beam 4 may be achieved by a motorized adjustment of at least a part of the collimation optics 17 and/or the focusing optics 18. For this purpose, at least a part of the collimation optics 17 and/or the focusing optics 18 may be displaced along the propagation direction of the laser beam 4 by a motor, for example by means of an actuator (not shown here). The laser beam 4 runs along the optical path 11 (of the laser beam).

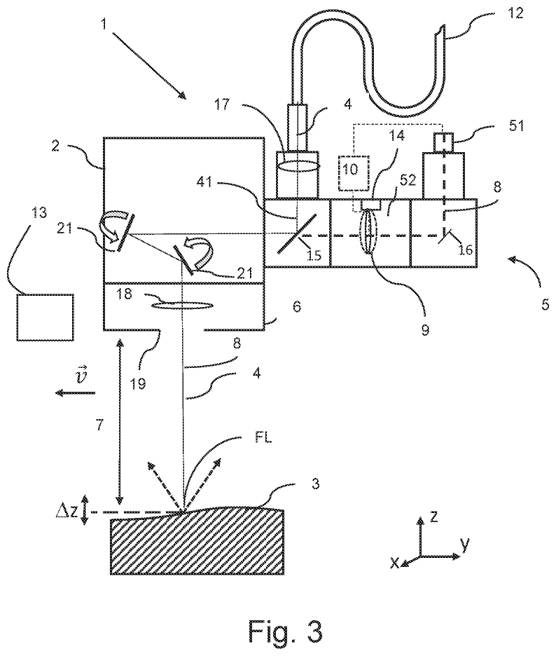

Although the laser machining head 1 is shown as a fixed optics head in FIG. 1, the laser machining head 1 may be a scanner laser machining head. In this case, the laser machining head 1 may include a scanning device instead of the deflection mirror 22, for example as shown in FIG. 3.

Moreover, the laser machining head 1 of FIG. 1 includes an image acquisition device 5 for acquiring an image of the workpiece surface 3. The image acquisition device 5 may be a gray image camera, for example. The image acquisition device 5 includes an objective 52 with a lens 9 having an adjustable focal length. The lens 9 may be a liquid lens, for example. The lens 52 is used to project an image onto a sensor 51 of the image acquisition device 5. The beam path of the image acquisition device 5, i.e. the imaging beam path 8, extends between the sensor 51 and the workpiece surface 3 via the deflection mirror 16, through the lens 9, the beam splitter or dichroic mirror 15, the deflection mirror 22, the focusing optics 18 and the exit opening 19 of the laser machining head 1. Of course, the imaging beam path 8 may be configured without the deflection minor 16, e.g. when the sensor 51 is arranged on the optical axis of the lens 9. The imaging optical path 8 has a portion that is not overlapped with the optical path 11 of the laser beam 4 and a portion that is coaxial with the optical path 11 of the laser beam 4.

In addition, the laser machining head 1 of FIG. 1 includes a control 10 configured to adjust the focal length of the lens 9 based on a measurement value, for example in such a way that with the adjusted focal length of the lens 9, the focal position FL of the image acquisition device 5 corresponds to the current position of the laser beam 4 on the workpiece surface 3. The focal position FL may be changed, for example, by a change in focal length Δz. Focusing times of up to 5 ms can be achieved depending on the size of the focus tracking or focal length change of the lens 9.

The measurement value may comprise a measured distance value of a distance 7 between the laser machining head 1 and the workpiece surface 3. Optionally, an optional distance measuring device 13 for measuring the measured distance value may be provided as an external element or an element integrated into the laser machining head 1. The optional distance measuring device 13 is not specified in more detail in FIG. 1 and is arranged next to the laser machining head 1 by way of example. The distance measuring device 13 may be one of the following devices: an optical coherence tomography (OCT) device, a lidar device, a ladar device, a ToF device, a conoscopy device, a light section device, a triangulation measuring device or a capacitive distance measuring device. In this case, the lens 9, e.g. the liquid lens, may be driven on the basis of measured distance values, which are obtained, for example, by an OCT measurement.

The control 10 may be configured to determine a contrast value from the image acquired by the image acquisition device 5 and to adjust the focal length of the lens 9 based on the contrast value in an autofocus function. A distance value of the distance 7 between the laser machining head 1 and the workpiece surface 3 may also be determined from the contrast value and a focal length of the lens 9 set when acquiring the underlying image. Thus, as an alternative to control based on a measured distance value, the image may be focused or the lens 9 may be controlled for adjusting the focal length on the basis of contrast values in the image. In this case, the focal length of the lens 52 effectively determined therefrom itself may be used to determine the distance and this value may then be used, for example, to control a motor-adjustable part of the collimating optics 17 of the laser beam 4.

In summary, the control 10 may be configured to adjust a focal position of the laser beam 4 by adjusting the collimating optics 17 and/or the focusing optics 18 based on the measurement value, the measured distance value, the contrast value or the distance value.

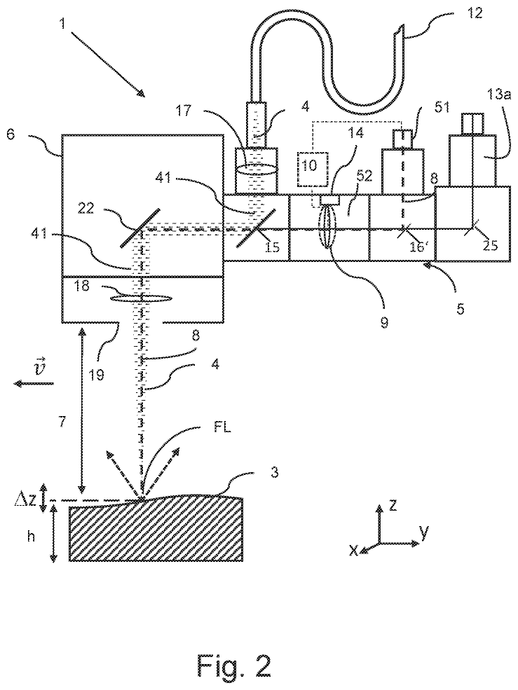

FIG. 2 is a schematic view of a laser machining head 1 according to another embodiment. Specifically, the laser machining head 1 differs from that of FIG. 1 in that the distance measuring device 13 is implemented as an OCT device 13a. The OCT device 13a may be arranged behind the image acquisition device 5, for example. A beam path of the OCT device 13a may be coupled into the beam path 8 of the image acquisition device 5 via a deflection mirror 25. The OCT device 13a is configured to acquire the distance 7 between the workpiece surface 3 and the laser machining head 1 by means of optical coherence tomography.

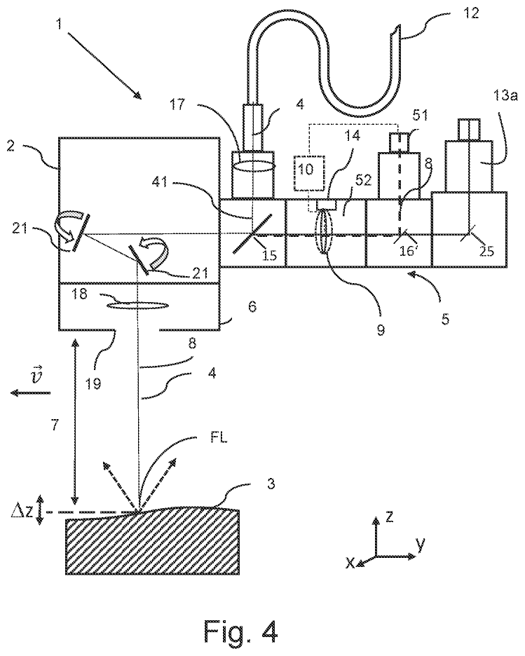

While the laser machining head 1 is shown as a fixed optics head in FIG. 2, the laser machining head 1 may be a scanner laser machining head. In this case, the laser machining head 1 may include a scanning device 2 instead of the deflection mirror 22, for example as shown in FIG. 4.

FIG. 3 is a schematic view of a laser machining head 1 according to a another embodiment, wherein a scanning device 2 for directing the laser beam 4 at different positions on the workpiece surface 3 is additionally provided. For this purpose, the scanning device 2 includes, for example, two mirrors 20 that are movable, in particular rotatable and/or pivotable about different axes, so that the laser beam 4 can be guided over the workpiece surface 3 in two dimensions along a predetermined path. The other features of the embodiment of FIG. 3 are essentially the same as those of the embodiment of FIG. 1.

FIG. 4 is a schematic view of a laser machining head 1 according to another embodiment, wherein a scanning device 2 is provided as in FIG. 3. The laser machining head 1 of FIG. 4 differs from the laser machining head shown in FIG. 3 only in that the distance measuring device 13 is implemented as an OCT device 13a.

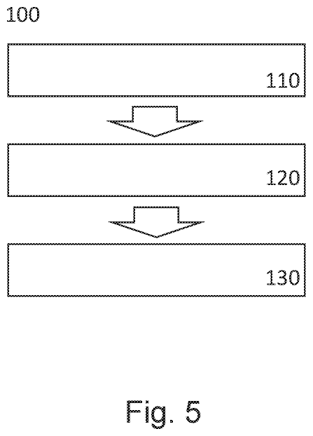

FIG. 5 schematically shows a method 100 according to an embodiment for machining a workpiece by means of a laser beam 4 by a laser machining head 1 with an image acquisition device 5 that includes an objective with a lens 9 that has an adjustable focal length. The method 100 includes: acquiring 110 a measurement value from or on the workpiece surface, adjusting 120 the focal length of the lens 9, e.g. a liquid lens, based on the acquired measured value, and acquiring 130 an image of the workpiece surface 3 by means of the image acquisition device 5, such as a gray image camera. The focal length of the lens 9 may be set, changed and/or adjusted by means of an actuator 14, for example.

In an example of a method 100 according to the present invention, the workpiece and/or the laser machining head may first be positioned. Then in step 110, for example by means of an OCT measuring device, a distance measurement may be carried out to acquire a measured distance value at a predetermined position of the workpiece, e.g. at the position of a marking or a specific feature on the workpiece surface 3. Based on the acquired measured distance value, the focal length of the lens 9 may be adjusted (step 120). In other words, the predetermined position on the work surface 3 may be brought into focus by adjusting the focal length of the lens 9. The image of the workpiece surface acquired in step 130 may be evaluated, e.g. by image processing, in order to determine a machining position of the laser beam 4 on the workpiece surface 3. Furthermore, the method 100 may include the step of directing the laser beam 4, e.g. by means of the scanning device 2, at the specific machining position.

In another example of a method 100 according to the present invention, the workpiece and/or the laser machining head may first be positioned. The image acquisition device 5 may then carry out (gray) image sharpening, e.g. via an autofocus function. For this purpose, for example, a contrast value of the workpiece surface 3 may be acquired by the image acquisition device 5 or the control 10 and the focal length of the lens 9 may be adjusted accordingly (step 120) in order to put the workpiece surface into focus. The image of the workpiece surface acquired in step may can in turn be evaluated, e.g. by image processing, in order to determine a machining position of the laser beam 4 on the workpiece surface 3. Furthermore, the method 100 may comprise the step of directing the laser beam 4, e.g. by means of the scanning device 2, at the specific machining position. Alternatively or additionally, the method may comprise: determining a distance value from the contrast value and, if necessary, the set focal length of the lens 9, and adjusting the focal position of the laser beam 4 based on the distance value, e.g. by displacing at least part of the focusing optics and/or the collimating optics by means of an actuator (not shown).

By using a lens with an adjustable or variable focal length, such as a liquid lens, in a lens for an image acquisition device of a laser machining head, in particular a scanner machining head, a sharp gray image can be achieved in each machining level. In addition, it is possible to set up a system with higher dynamics than with manual or motorized adjustment. The structure can also be made more compact and less expensive.

### LIST OF REFERENCE SYMBOLS

1 laser machining head
2 scanning device
3 workpiece surface
4 laser beam
41 beam path of the laser beam
5 image acquisition device
51 sensor
6 housing
7 distance between workpiece surface and laser machining head
8 imaging beam path or beam path of the image acquisition device
9 lens with adjustable focal length
10 control
12 light guide
13 distance measuring device
13a OCT measuring device
14 actuator
15 dichroic minor
16 deflection minor
16′ beam splitter or dichroic minor
52 lens
17 collimating optics
18 focusing optics
19 exit opening
21 movable (rotatable/pivotable) mirror
22 deflection minor
25 deflection minor
100 method for machining a workpiece using a laser beam
110 acquiring a measurement value
120 adjusting the focal length of the lens based on the acquired measurement value
130 acquiring an image of the workpiece surface by means an image acquisition device with the adjusted focal length
Δz focal length change
h height h of machining on the workpiece surface relative to an arbitrary reference point, preferably in the z-direction
FL focal position of the imaging beam path

1. A laser machining head for machining a workpiece by a laser beam, comprising:
a scanning device for directing said laser beam at a plurality of positions on a workpiece surface;
an image acquisition device for acquiring an image of said workpiece surface, said image acquisition device comprising an objective with a lens having an adjustable focal length; and
a control configured to adjust a focal length of said lens based on a measurement value.

2. The laser machining head according to claim 1, wherein said lens is a liquid lens and/or has a focal length range between −500 mm and +500 mm, between −500 mm and +333 mm or between −100 mm and +100 mm.

3. The laser machining head according to claim 1, wherein said image acquisition device comprises a camera or a gray image camera.

4. The laser machining head according to claim 1, wherein a beam path of said image acquisition device extends at least partially coaxially with said beam path of said laser beam.

5. The laser machining head according to claim 4, wherein said scanning device is arranged in an area in which said beam path of said image acquisition device extends coaxially with said beam path of said laser beam.

6. The laser machining head according to claim 1, wherein the measurement value is a distance measurement value of a distance between said laser machining head and said workpiece surface.

7. The laser machining head according to claim 6, further comprising:
a distance measuring device for measuring the distance value.

8. The laser machining head according to claim 7, wherein said distance measuring device comprises at least one of the following devices: an optical coherence tomography (OCT) device, a lidar device, a ladar device, a ToF device, a conoscopy device, a light section device, a triangulation measuring device and a capacitive distance measuring device.

9. The laser machining head according to claim 1, wherein the measurement value is a contrast value of an image of said workpiece surface acquired by said image acquisition device.

10. The laser machining head according to claim 9, wherein said control is configured to determine a distance value of said laser machining head to said workpiece surface from the contrast value of the acquired image and a focal length set when acquiring the image.

11. The laser machining head according to claim 1, wherein:
said control is configured to adjust the focal length of said lens in such a way that an area of said workpiece surface in which the measurement value was acquired lies in the focal plane of said image acquisition device; and/or
said control is configured to control said image acquisition device in order to carry out an autofocus function.

12. The laser machining head according to claim 1, further comprising:
a collimating optics for collimating said laser beam; and
a focusing optics for focusing said laser beam;
wherein at least a part of the focusing optics and/or the collimating optics is displaceable by means of an actuator; and
wherein said control is configured to adjust a focal position of said laser beam based on the measurement value by controlling the actuator.

13. A method for machining a workpiece a laser beam via a laser machining head with an image acquisition device, which includes an objective with a lens having an adjustable focal length, said method comprising:
acquiring a measurement value;
adjusting the focal length of said lens based on the measurement value; and
acquiring an image of said workpiece surface by means of said image acquisition device with the adjusted focal length.

14. The method according to claim 13, further comprising:
acquiring the measurement value at a position on said workpiece surface which is to lie in the focal plane of said image acquisition device.

15. The method according to claim 13, wherein acquiring a measurement value comprises:
acquiring a distance measurement value, wherein the focal length of said lens is adjusted based on the acquired distance measurement value; and/or
acquiring a contrast value in an image of said workpiece surface, wherein the focal length of said lens is adjusted based on the acquired contrast value.

16. The method according to claim 13, further comprising:
evaluating the acquired image and determining a machining position on the workpiece surface for said laser beam.
